(19) United States
(12) Patent Application Publication
(10) Pub. No.: US 2012/0329168 A1
(43) Pub. Date: Dec. 27, 2012

(54) DRUG DETECTION METHOD AND APPARATUS

(76) Inventors: Po-Tsang LIN, Taipei City (TW); Shu-Liang LIAW, Taoyuan County (TW)

(21) Appl. No.: 13/524,452

(22) Filed: Jun. 15, 2012

(30) Foreign Application Priority Data
Jun. 21, 2011 (TW) 100121696

(51) Int. Cl. G01N 21/80

(52) U.S. Cl. 436/144; 422/86

(57) ABSTRACT

A drug detection apparatus for identifying whether a gas sample contains an acidic gas includes a reactor having a gas inlet, a detection reagent containing an oxidant and a reductant, and a catalyst triggering a chemical adsorption with the oxidant and the reductant. A drug detection method applied to a drug detection apparatus is also disclosed. The drug detection apparatus and method can detect the acidic gases from drugs immediately, sensitively and selectively, thereby improving the efficiency of suspect inspection of drug smuggling in airports.

### CROSS REFERENCE TO RELATED APPLICATIONS

This Non-provisional application claims priority under 35 U.S.C. §119(a) on Patent Application No(s). 100121696 filed in Taiwan, Republic of China on Jun. 21, 2011, the entire contents of which are hereby incorporated by reference.

### BACKGROUND OF THE INVENTION

1. Field of Invention

The present invention relates to a detection method and a detection apparatus, and in particular, to a drug detection method and apparatus.

2. Related Art

International drug smuggling is a global illicit crime and the smuggler undoubtedly be punished by death penalty in many countries like Singapore, Malaysia and Mainland China. Unfortunately, huge market benefit promotes smugglings growing at full speed. According to UNODC (United Nations Office on Drugs and Crime), the annual market value of drug trafficking is estimate to few billion U.S. dollars. To make sure drug delivery in safety and speed, air traffic has become important tunnel for trafficking.

FIG. 1A is illustrating the conventional inspection procedure in U.S.A and some countries in Europe. FIG. 1B is illustrating a conventional modified inspection procedure relative to the procedure shown as FIG. 1A. The regulated route for the passengers is presented as dashed arrow in the FIGS. 1A and 1B, and the regulated route for the traffickers suspect is presented as solid arrow in the FIGS. 1A and 1B. At present time x-ray scanners are used worldwide for examination of air cargoes including luggage. To keep homeland security, as shown in FIG. 1A, U.S.A and some countries in Europe permit intrusive searches to air passenger at area A. Even the customs authority clams that customs officers P will conduct all searches in a consistent and professional manner. Passengers are to be treated with respect and courtesy. The customs officers P still have huge controversy and inefficient customs clearance at area C. Thus, online non-contact sensing equipments are long needed to assist staff in overall identifying smuggling suspect as shown in FIG. 1B. The clothed passengers could walk though the devices d set on destination sites D. Any passengers, especially trafficker suspects, with possible presentation would be conducted to search zoom aside for further investigation at area S (shown in FIGS. 1A and 1B). The main advantage is improvement of deterrence, customs clearance efficiency and human rights protection.

Some detectors by analytical technologies of ITMS, QCM, MOS and GC-FID&TCD have currently served some international airports in U.S.A and Europe. They are EntryScan4 of General Electric Company, GE, Explosive Trace Detection System, Scent Detection Technologies (SDT), Israel and portal VOC tracer. Despite excellent identification of molecules structure, the equipments are still for offline examination from disadvantages of expensive price of $1,000,000-3,000,000 and time-consuming of 15-20 min.

### SUMMARY OF THE INVENTION

In view of the foregoing, the purpose of the present invention is to provide a drug detection method and apparatus to improve the efficiency of finding suspects of drug smuggling at the airports under human rights protection.

To achieve the purpose as described above, a drug detection apparatus for identifying whether a gas sample contains an acidic gas includes a reactor having a gas inlet, a detection reagent containing an oxidant and a reductant, and a catalyst triggering a chemical adsorption reaction with the oxidant and the reductant.

In one embodiment of the present invention, the gas sample contacts with the detection reagent through the gas inlet.

In one embodiment of the present invention, the drugs detection apparatus further includes a stirrer disposed in the reactor to swirl the detection reagent.

In one embodiment of the present invention, the drug detection further includes a guiding unit introducing the gas sample into the detection reagent.

In one embodiment of the present invention, the oxidant includes hydrogen peroxide, ozone, potassium permanganate, or sodium chlorate.

In one embodiment of the present invention, the reductant is a halogeneted metal compound having color developing ability.

In one embodiment of the present invention, the reductant includes potassium iodide, potassium chloride, or potassium bromide.

In one embodiment of the present invention, the catalyst is disposed on the inner surface of the reactor or added in the detection reagent.

In one embodiment of the present invention, the catalyst includes ferric iron oxide, cupper oxide, silver oxide, nickel oxide, ferrious oxide, chromium oxide, cerium oxide, molybdenum sesquioxide, tricobalt tetraoxide, vanadium pentaoxide, or silicon dioxide.

In one embodiment of the present invention, the concentration of the oxidant is between 0.15 M and 1.5 M.

In one embodiment of the present invention, the concentration of the reductant is between 0.25 M and 2.5 M.

In one embodiment of the present invention, the drug detection apparatus further includes a monitoring unit detecting a change in the color of the detection reagent.

In one embodiment of the present invention, the monitoring unit is an image capturing and analyzing unit.

In one embodiment of the present invention, the drug detection apparatus further includes a warning unit electrically connected with the monitoring unit.

The present invention also provides a drug detection method applied to a drug detection apparatus. The drug detection apparatus includes a reactor, a detection reagent and a catalyst. The steps of the method of the present invention include collecting a gas sample, dissolving the gas sample into the detection reagent to react with the catalyst, an oxidant and a reductant and detecting a color change in the detection reagent and determining whether the degree of the color change is greater than a threshold value.

In one embodiment of the present invention, the step of dissolving the gas sample into the detection reagent to react with the catalyst, the oxidant and the reductant results in a reaction with a color change in the detection reagent.

In one embodiment of the present invention, the step of detecting a change in the color of the detection reagent and determining whether the degree of the color change is greater than a threshold value is achieved by using naked eyes or an image capturing and analyzing unit.

In one embodiment of the present invention, the drug apparatus further includes generating a warning signal when the degree of the color change of the detection reagent is greater than the threshold value.

In summary, the drug detection apparatus and the drug detection method of the present invention can effectively detect trace of acidic gases through dissolving the gas sample into the detection reagent and contacting with the catalyst to generate a serial of chain reactions resulting in a color change in the detection reagent. Therefore, the drug detection apparatus and the drug detection method of the present invention can be used to primarily detect drugs and have the advantages of immediately detecting, reducing production cost and high sensitivity, so that they are suitable for detecting drugs at border inspection stations where the large number of crowd frequently passing through.

### BRIEF DESCRIPTION OF THE DRAWINGS

FIG. 1A is a schematic figure illustrating a conventional inspection procedure with intrusive researches in U.S.A and some countries in Europe;

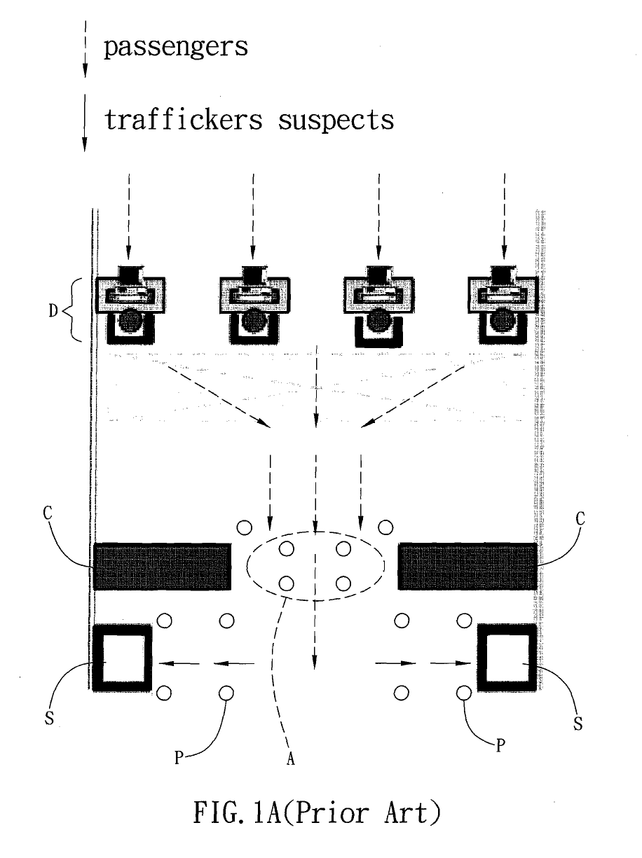

FIG. 1B is a schematic figure illustrating a conventional modified inspection procedure with on-line suspect inspecting devices;

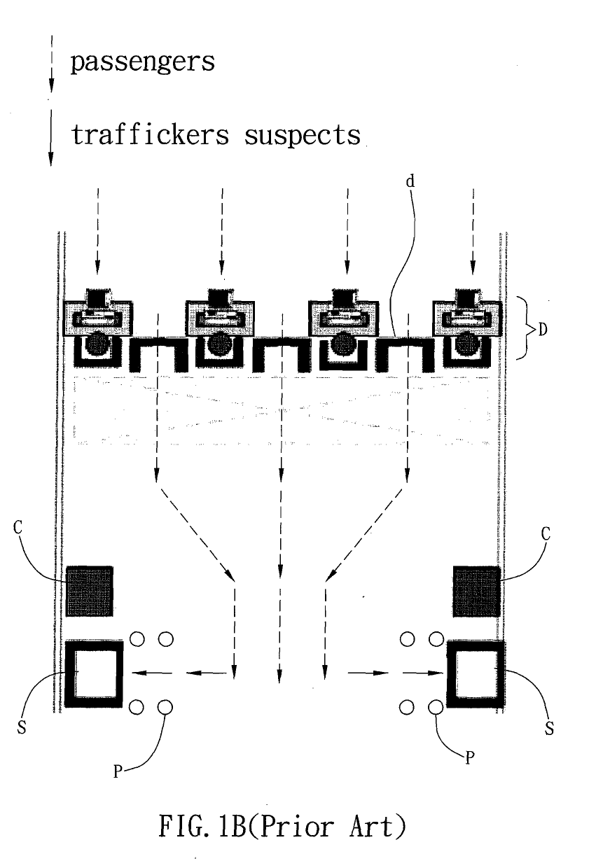

FIG. 2A is a schematic figure illustrating the drug detection apparatus in accordance with the first embodiment of the present invention;

FIG. 2B is a schematic figure illustrating the drug detection apparatus in accordance with the first aspect of the present invention;

FIG. 2C is a schematic figure illustrating the drug detection apparatus in accordance with the second aspect of the present invention;

FIG. 2D is a schematic figure illustrating the drug detection apparatus in accordance with the second embodiment of the present invention;

FIG. 3 is a flowchart of the drug detection method in accordance with the present invention;

FIG. 4 shows the data of detecting the volatile organic compound by the drug detection apparatus in accordance with the present invention; and

FIG. 5 shows the data of detecting heroin and amphetamine by the drug detection apparatus in accordance with the present invention.

### DETAILED DESCRIPTION OF THE INVENTION

The present invention will be apparent from the following detailed description, which proceeds with reference to the accompanying drawings, wherein the same references relate to the same elements.

In the process of manufacturing drugs, many acidic solutions such as acetic acid, phosphoric acid and hydrochloric acid are usually used as reactants. Because smuggled drugs are secretly manufactured without deacidifying, a lot of incompletely reacted acidic substances remain in the drugs. The smuggled drugs are usually packed with materials made of polymers such as polyvinyl chloride (PVC) or polypropylene (PP). After being delivered for several hours, the acidic substances in the drugs evaporate to acidic gases and permeate through the materials as mentioned above under the condition of 1 atmosphere, 35° C. Hence, it is considerably possible to primarily detect drug via detecting whether unusual acidic gases exist nearby the surface of clothed individual. It needs to be noted that the smell of perfumes and fruit could not interfere with the detection of drugs by the drug detection apparatus of the present invention, and this will be described in the following description.

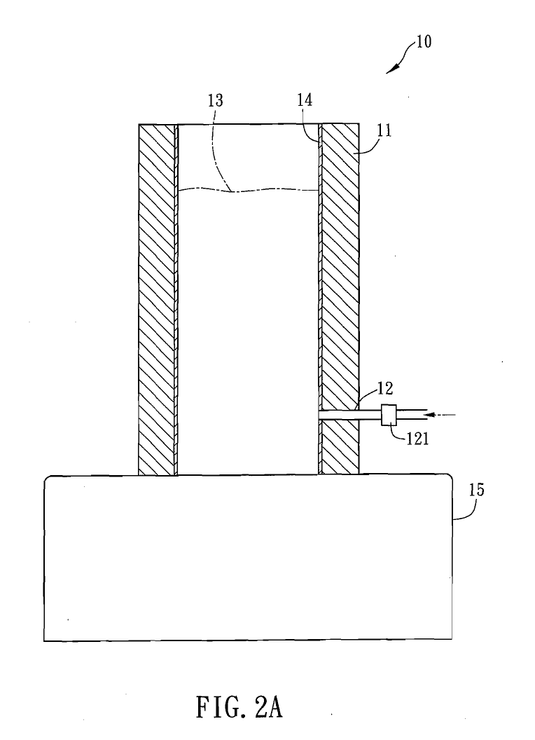

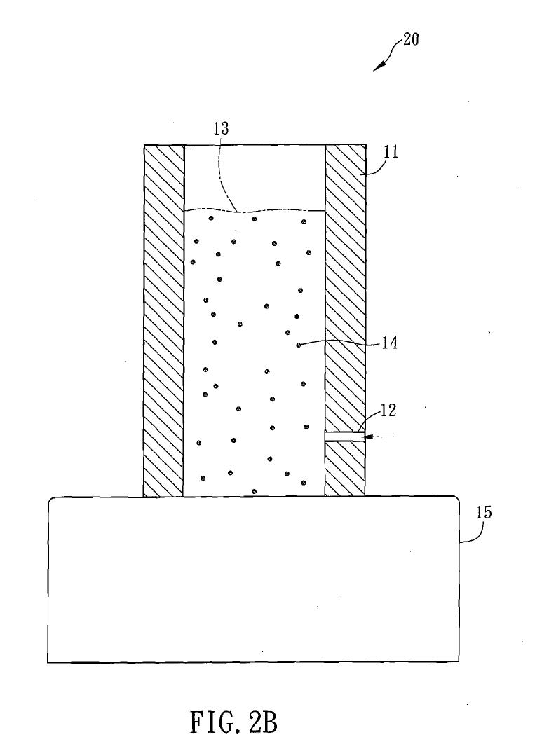

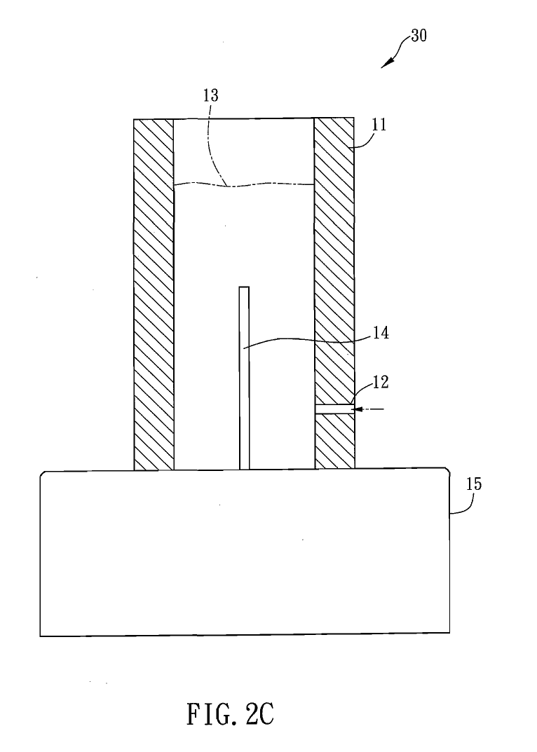

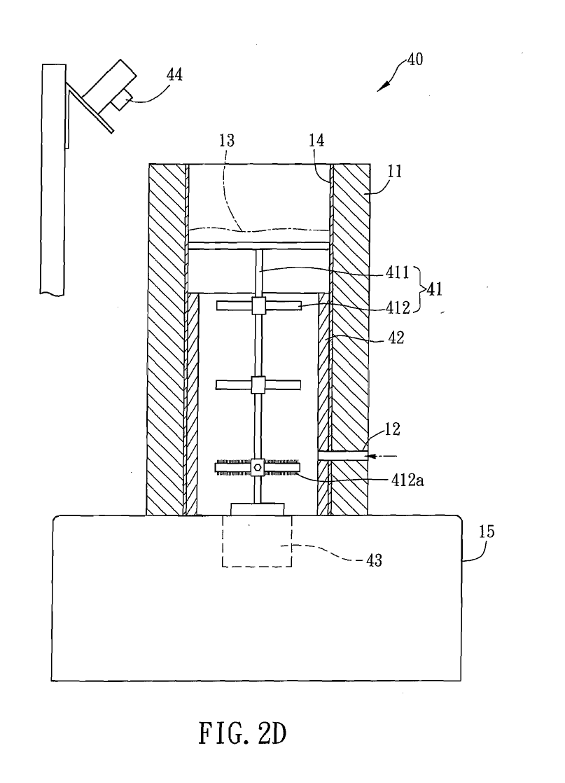

FIG. 2A is a schematic figure illustrating the drugs detection apparatus in accordance with the first embodiment of the present invention. As shown in FIG. 2A, the drugs apparatus 10 includes a reactor 11, a detection reagent 13 containing an oxidant and a reductant and a catalyst 14.

Reactor 11 is, for example, a cylindrical container, and there is a space with 500-mL volume in the center of the reactor 11. Of course, except for cylindrical container, the shape of the reactor 11 can for example but not limited to be square, polyhedral, circular or other shaped. The side portion of the reactor 11 has a gas inlet 12 collecting a gas sample in the air and introducing into the reactor 11 to contact with the detection reagent 13. To improve the efficiency of collecting gas sample and mixing the gas sample and the detection reagent 13, in this embodiment, the gas inlet 12 can be equipped with a guiding unit 121, and the guiding unit 121 can have, for example, an extracting air element, and the extracting air element can rapidly extract gas sample from the environmental air, and then the gas sample can be introduced through the gas inlet 12 and mixed to the detection reagent 13.

The detection reagent 13 is disposed in the space in the center of the reactor 11 and contains an oxidant and a reductant, the volume of the detection reagent 13 is 500 mL. It should be noted that, the term “oxidant” herein refers to a dual reagent, which can serve as an oxidant under acidic environment, and serve as a reductant under basic environment. The oxidant in the detection reagent 13 includes hydrogen peroxide, ozone, potassium permanganate, sodium chlorate, or the combinations thereof. The concentration of the oxidant is between 0.15 M and 1.5 M. The reductant in the detection reagent 13 includes halogeneted metal compounds such as potassium iodide (KI), potassium chloride (KCl), or potassium bromide (KBr). The concentration of the reductant is between 0.25 M and 2.5 M. It should be noted that the concentrations of the oxidant and reductant are relatively excessive compared with the concentration of the hydrogen ion (H⁺) in the gas sample, such that the amounts of the oxidant and the reductant are enough to involve a serial of chain reactions and repeatedly detect different gas samples. Therefore, this may not cause a variance to the detection results.

The catalyst 14 can be disposed on the inner surface of the reactor 11 or added in the detection reagent 13. In this embodiment, the catalyst 14 is coated on the inner surface of the reactor 11 at a high temperature. The catalyst 14 includes ferric iron oxide (FeO(OH)), cupper oxide (CuO), silver oxide (Ag₂O), nickel oxide (NiO), ferrious oxide (Fe₂O₃), chromium oxide (Cr₂O₃), cerium oxide (Ce₂O₃), molybdenum sesquioxide (Mn₂O₃), tricobalt tetraoxide (Co₃O₄), vanadium pentaoxide (V₂O₅), or silicon dioxide (SiO₂). The catalyst 14 of another aspect of the present invention is shown in FIG. 2B. As shown in FIG. 2B, the catalyst 14 is dissolved or suspended in the detection reagent 13. As shown in FIG. 2C, the catalyst 14 can also be molded into a columnar form, and the catalyst 14 can gradually dissolve when the detection reagent 13 is stirred or flows. In this embodiment, energy generated by heating the detection reagent 13 to 70˜80° C. is enough to overcome the energy barrier of the chemical reaction of the catalyst, oxidant and reductant, so as to successfully generate the following chemical reactions.

To dissolve the extremely trace amounts of the hydrogen ions of the acidic gases into the detection reagent 13, the drugs detection apparatus of the present invention further includes a stirrer. As shown in the FIG. 2D, a stirrer 41 is disposed in the space in the center of the drugs detection apparatus 40. The stirrer 41 includes rotating shaft 411 and a plurality of impellers 412, and an example of the number of the impellers 412 are six herein. The impellers 412 are disposed in pair in the rotating shaft 411, and each pair of the impellers 412 is separately disposed along the rotating shaft 411. However, the number of the impeller 412 of the present invention can be more or less than six depending on the requirements. Besides, the drugs detection apparatus 40 can further includes a motor 43. The motor 43 is disposed on the base 15 and electrically connected with the rotating shaft 411. When the motor 43 runs, the rotating shaft 411 is driven and swirls, such that the detection reagent 13 forms eddy currents. The configurations of a plurality of baffles 42 closely disposed to the inner wall of the reactor 11 or a plurality of steel pins 412a disposed on the impellers 412 are used to produce a turbulence, so as to improve the efficiency of dissolving the gas sample to the detection reagent 13.

The following will illustrate the chemical reactions generated in the drugs detection apparatus. The example of the gas sample, the oxidant and the reductant in the detection reagent 13 is acetic acid, hydrogen peroxide (H₂O₂) and potassium iodide (KI), respectively, and the example of the catalyst 14 is ferric iron oxide (FeO(OH)). When the hydrogen ions dissolve in the detection reagent 13 and contact with the catalyst 14, the following chemical reactions are generated:

Dissolution

CH₃COOH_{(g)}+H₂O₂+KI→CH₃COO⁻+H⁺+H₂O₂+K⁺+I⁻

Oxidization

H₂O_{2(aq)}+2H⁺+2I⁻→I₂+2H₂O

Absorption

FeO(OH)₍ₛ₎+H₂O_{2(aq)}→FeO(OH)—H₂O₂

FeO(OH)₍ₛ₎+I⁻→FeO(OH)—I⁻

Chain Reaction

FeO(OH)—H₂O₂→Fe²⁺—O₂+2HO.+1/2H₂

2Fe²⁺—O₂+H₂O→2FeO(OH)

Oxidization

2HO.+2I⁻→I₂+H₂O+1/2O₂

When the acetic acid is mixed in the detection reagent 13, the hydrogen ions also dissociate from the acetic acid in the detection reagent 13 and decrease the pH value of the detection reagent 13, such that the dual reagent, hydrogen peroxide, is being an oxidant herein. H₂O₂ can oxidize the iodine ions in the detection reagent 13 to molecular iodine so as to develop color. Simultaneously, the hydrogen peroxide are absorbed with ferric iron oxide through chemical absorption, and serious of large amounts of the free radicals with strong oxidizing potential such as HO., .O—, .O₂⁻ and .O₂⁺ are generated to proceed a serial of chain reactions, so as to oxidize more iodine ions and amplify the reaction of developing color caused by molecular iodine. Among the chemical equations mentioned above, the molecules with the ability of developing color are molecular iodine, and it results in a change of the color of the detection reagent 13 into brown. When the concentration of the hydrogen ions in the detection reagent 13 are gradually reduced due to consuming in a serial of chemical reactions, the pH value of the detection reagent 13 gradually restores to neutral and the hydrogen peroxide loses the oxidizing ability. Thus, the reaction of developing color is terminated.

The drugs detection apparatus 40 of the present invention can be further connected with a monitoring unit 44. The monitoring unit 44 can further includes an image capturing and analyzing unit. According to the results of the developing color of the detection reagent 13, the image capturing and analyzing unit can catch an image of the detection reagent 13 and determine whether the degree of the color change of the detection reagent 13 is greater than a threshold value. Certainly, the image capturing and analyzing unit can be also replaced by using naked eyes or other machines having the ability of discriminating the color difference to achieve the purpose of monitoring. The image capturing and analyzing unit has, for example, the combination of a camera 44 and image analysis software shown in the FIG. 2D. The camera 44 is disposed at a position around the reactor 11 to serially or randomly photographing.

To confirm whether the color change degree of the detection reagent 13 is greater than a threshold value, the image captured by the image capturing and analyzing unit is used to measure the value of gray by the image analysis software. A gray-I₂ quantity line is regressed according to the relationship between the values of gray of various known amounts (mole) of molecular iodine and the corresponding concentrations. Blank is estimated at 25° C., and the concentration of the molecular iodine of the blank is calculated according to the value of gray of blank and obtains the standard deviation (SD). The instruments detection limit (IDL) is determined by three times of the standard deviation. The situation of measured value of gray greater than IDL means that the color change degree of the detection reagent 13 is greater than the threshold value.

In this embodiment, the drug detection apparatus 40 is electrically connected with a warning unit (not shown). When the color change degree of the detection reagent 13 detected by the monitoring unit 44 is greater than the threshold value, it indicates that the monitored gas sample contains acidic gases. Then, the warning unit of the drug detection apparatus 40 generates a warning signal. The warning signal of the present invention includes a warning alarm or warning light, and it can be used to notify the detecting personnel of the border inspection.

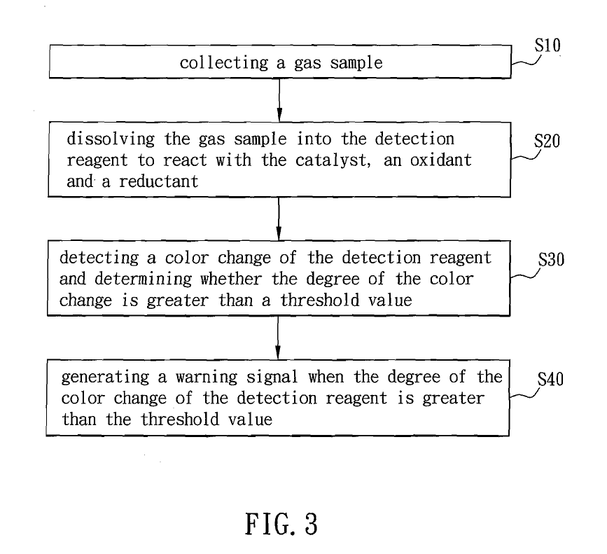

The present invention also provides a drug detection method applied to the drug detection apparatus. As shown in FIG. 3, the drug detection method includes the following steps of collecting a gas sample (step S10), dissolving the gas sample into the detection reagent to react with the catalyst, an oxidant and a reductant (step S20), and detecting a change in the color of the detection reagent and determining whether the change degree is greater than a threshold value (step S30). Additionally, the step of the drug detection method of the present invention further includes generating a warning signal when the degree of the color change in the detection reagent is greater than the threshold value (step S40). The detailed specification of the steps is described as mentioned above, and it is omitted herein.

In an embodiment of the present invention, it is demonstrates that the drug detection apparatus of the present invention can detect 1 ppb gaseous acetic acid. Moreover, the chemical reactions for detecting acidic gases in the drug detection apparatus of the present invention could not be effected by common odorous molecules originated from volatile organic compounds such as fruit odor, or perfume, thus, the drug detection of the present invention is highly sensitive. Because the chemical reactions can immediately complete in 1.5 seconds and sequentially develop color in the detection reagent, the drug detection of the present invention can rapidly detect gas samples. The chemical reactions for the detecting blank between two detection items can not be effected by the chemical reactions of previous test item, thus the detection of the drug detection apparatus of the present invention is extremely stable.

The characteristics of the drug detection apparatus in accordance with the present invention are further demonstrated by the following experiments.

Disposing the Drug Detection Apparatus

The drug detection apparatus of this experiment is shown in FIG. 2D. First of all, the detection reagent is prepared in the reactor. To prepare the detection reagent, weigh out 20 g of potassium iodide (KI) and 50 mL of 50% hydrogen peroxide (H₂O₂) and dissolve in distilled water. The final concentrations of KI and H₂O₂ in the detection reagent are 0.15 M and 0.25 M, respectively. The liquid level of the detection reagent is equal to the height of the rotating shaft in the reactor.

The catalyst used in this experiment is ferric iron oxide (FeO(OH)). 20 g of FeO(OH) is uniformly coated on the inner surface of the reactor at temperature of 500° C. Then, the detection reagent is heated, the stirrer whirls the detection reagent at speed of 1,800 rpm. The gas sample is extracted from the outside of the gas inlet, passes through the gas inlet and dissolves in the detection reagent. The operation of extracting the gas sample in this experiment is in semi-batch mode. The extracting period of the gas sample is approximately 3 seconds each time, and the volume of the extracted gas sample is about 0.1-1.0 NL/min each time. The gas samples used in this experiment are 1 ppb acetic acid gas and saturated vapors of 20 mL ethylene (a common volatile hormone in plants), perfume (CHANNEL NO. 5) and acetyl acetate.

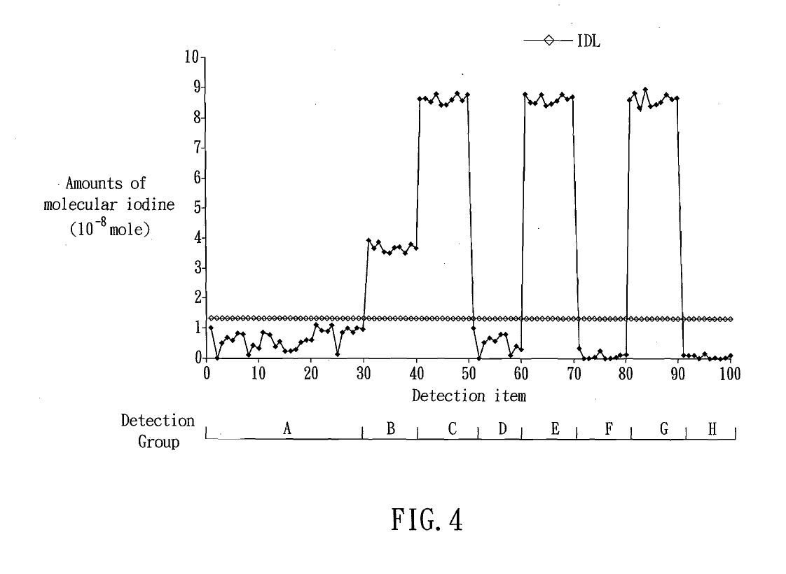

As shown in FIG. 4, different detecting conditions of acetic acid gas and saturated vapors of ethylene, perfume and acetyl acetate as gas samples are respectively grouped into detection groups A to H and detected by the drug detection apparatus. In detection group A, the gas sample is 1 ppb acetic acid gas, and the temperature of the detection reagent is controlled between 25˜60° C. In detection group B, the gas sample is 1 ppb acetic acid gas, and the temperature of the detection reagent is controlled at 70° C. In detection group C, the gas sample is 1 ppb acetic acid gas, and the temperature of the detection reagent is controlled at 80° C. In detection group D, the gas sample is 20 mL saturated vapor of ethylene, and the temperature of the detection reagent is controlled at 80° C. In detection group E, the gas sample is 1 ppb acetic acid gas, and the temperature of the detection reagent is controlled at 85° C. In detection group F, the gas sample is 20 mL saturated vapor of perfume, and the temperature of the detection reagent is controlled at 80° C. In detection group G, the gas sample is 1 ppb acetic acid gas, and the temperature of the detection reagent is controlled at 90° C. In the detection group H, the gas sample is 20 mL saturated vapor of acetyl acetate, and the temperature of the detection reagent is controlled at 80° C.

As shown in FIG. 4, the amounts of the molecular iodine in each detection item of detection group D, detection group F and detection group H is lower that IDL (1.35×10⁻⁸ mole). This indicates that the common volatile compound such as ethylene, perfume and acetyl acetate could not generate chemical reactions in the drug detection apparatus of the present invention to interfere with the chemical reactions in the detection process. Furthermore, the energy generated by heating the detection reagent up to 70° C. are enough to process a serious of chemical reactions to develop color in the detection reagent. However, the amounts of the molecular iodine will not obviously increase as the detection reagent is heated to higher temperature such as 80° C., 85° C. and 90° C.

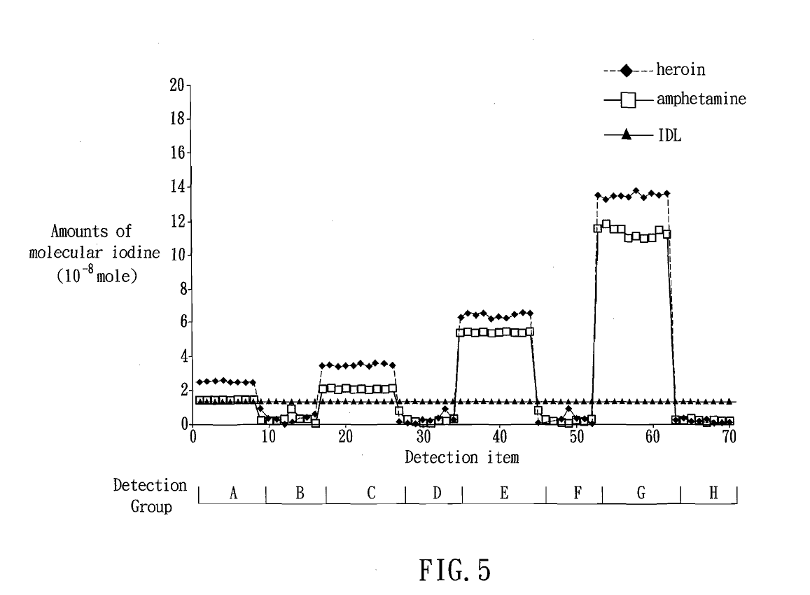

FIG. 5 shows a data of 1 g heroin and amphetamine as emission source of drug odor detected by the drug detection apparatus of the present invention. In detection group A, 0.1 L of heroin and amphetamine are extracted and introduced to the detection reagent. In detection group C, 0.3 L of heroin and amphetamine are extracted and introduced to the detection reagent. In detection group E, 0.5 L of heroin and amphetamine are extracted and introduced to the detection reagent. In detection group G, 1 L of heroin and amphetamine are extracted and introduced to the detection reagent. Detection groups B, D, F and H are detecting blank prior to detecting next gas sample. The retention time of each detection item of each detection group is 1.5 seconds, and the temperature of the detection reagent is controlled at 70° C. As shown in FIG. 5, the amounts of molecular iodine are generated from low to high in detection group A, detection group C, detection group E and detection group G in order. This indicates that more amounts of the molecular iodine are going to be generated if more volume of the drugs gas is extracted and dissolved to the detection reagent. In addition, the detecting results in detection group B, detection group D, detection group F and detection group H as detecting blank are not individually effected by chemical reactions generated in their previous detection group, so this demonstrates that the drug detection apparatus of the present invention has excellent detection stability.

In summary, the drug detection apparatus and the drug detection method of the present invention can effectively detect trace of acidic gases through dissolving the gas sample into the detection reagent and contacting with the catalyst to generate a serial of chain reactions resulting in a color change in the detection reagent. Therefore, the drug detection apparatus and the drug detection method of the present invention can be used to primarily detect drugs and have the advantages of immediately detecting, reducing production cost and high sensitivity, so that they are suitable to be used to detect drugs at border inspection stations where the large number of crowd frequently passed through.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A drug detection apparatus for identifying whether a gas sample contains an acidic gas, comprising:
a reactor having a gas inlet;
a detection reagent containing an oxidant and a reductant; and
a catalyst triggering a chemical adsorption reaction with the oxidant and the reductant.

2. The apparatus of claim 1, wherein the gas sample contacts with the detection reagent through the gas inlet.

3. The apparatus of claim 1, further comprising:
a stirrer disposed in the reactor to swirl the detection reagent.

4. The apparatus of claim 1, further comprising:
a guiding unit introducing the gas sample into the detection reagent.

5. The apparatus of claim 1, wherein the oxidant comprises hydrogen peroxide, ozone, potassium permanganate, or sodium chlorate.

6. The apparatus of claim 1, wherein the reductant is a halogeneted metal compound having color developing ability.

7. The apparatus of claim 1, wherein the reductant comprises potassium iodide, potassium chloride, or potassium bromide.

8. The apparatus of claim 1, wherein the catalyst is disposed on the inner surface of the reactor or added in the detection reagent.

9. The apparatus of claim 1, wherein the catalyst comprises ferric iron oxide, cupper oxide, silver oxide, nickel oxide, ferrious oxide, chromium oxide, cerium oxide, molybdenum sesquioxide, tricobalt tetraoxide, vanadium pentaoxide, or silicon dioxide.

10. The apparatus of claim 1, wherein the concentration of the oxidant is between 0.15 M and 1.5 M.

11. The apparatus of claim 1, wherein the concentration of the reductant is between 0.25 M and 2.5 M.

12. The apparatus of claim 1, further comprising:
a monitoring unit detecting a color change in the detection reagent.

13. The apparatus of claim 12, wherein the monitoring unit is a capturing and analyzing an image unit.

14. The apparatus of claim 12, further comprising:
a warning unit electrically connected with the monitoring unit.

15. A drug detection method applied to a drug detection apparatus, wherein the drug detection apparatus comprises a reactor, a detection reagent and a catalyst, the method comprising:
collecting a gas sample;
dissolving the gas sample into the detection reagent to react with the catalyst, an oxidant and a reductant; and
detecting a color change of the detection reagent and determining whether the degree of the color change is greater than a threshold value.

16. The method of claim 15, wherein the step of dissolving the gas sample into the detection reagent to react with the catalyst, the oxidant and the reductant results in a reaction with a color change in the detection reagent.

17. The method of claim 15, wherein the step of detecting a change in the color of the detection reagent and determining whether the degree of the color change is greater than a threshold value is achieved by using naked eyes or an image capturing and analyzing unit.

18. The method of claim 17, further comprising:
generating a warning signal when the degree of the color change of the detection reagent is greater than the threshold value.
